(19) United States
(12) Patent Application Publication
(10) Pub. No.: US 2009/0195810 A1
(43) Pub. Date: Aug. 6, 2009

(54) PRINTER DRIVER APPARATUS AND METHODS

(75) Inventors: Mary Ann SPRAGUE, Macedon, NY (US); Geoffrey WOOLFE, Canandaigua, NY (US)

Correspondence Address: Prass LLP, 2661 Riva Road, Building 1000, Suite 1044, Annapolis, MD, 21401, US

(73) Assignee: XEROX CORPORATION, Norwalk, CT (US)

(21) Appl. No.: 12/025,230

(22) Filed: Feb. 4, 2008

(51) Int. Cl. G06K 15/00

(52) U.S. Cl. 358/1.15

(57) ABSTRACT

Disclosed are methods of controlling operation of a printer, apparatus and computer-readable medium. The embodiments control operation of a printer by receiving a print command from a user, in response to the received print command, displaying to a user a print user interface including selectable editing settings, the selectable editing settings including settings for varying attributes of a document to be printed, the editing settings for varying formatting of the document to enhance editing by hand of the printed document; receiving from a user a selection of the editing settings; and controlling printing of the document to print on the printer by varying formatting of the document using the selected editing settings.

### BACKGROUND

Disclosed herein are methods for controlling printing, as well as corresponding apparatus and computer-readable medium.

Image forming devices such as printers, copiers and multi-function devices provide users the ability to print from a device such as a desktop or laptop computer, a handheld computer, or other electronic devices, to a printer connected to the device. The electronic devices may be stand alone devices, or may be connected in a network, such as in a business computing environment, which may include one or more printers.

In order for a printer to interface with and function with the computer or electronic device to which it is connected, a printer driver can typically be installed on the computer. A printer driver is software which controls the printer from the computer. The printer driver may include a user interface that may be typically accessed by a user through an operating system or an application program, such as a word processing program, a spreadsheet program, or other types of programs, and viewed on a display.

Documents are often printed to be used as working copies such as when a user is reviewing and editing a document. The user may edit the document by annotation such as by hand or other markups, prior to finalizing the document. In such cases, the preferred formatting and finishing of the document for use as a working copy may be different from what is required for an edited or final distribution version of the document. For example, when printing out a document for editing, there may not be enough space for editing annotation, such as hand written notes, on the hard copy of the document. It may also be difficult to reference or bookmark a specific line of text in the hard copy of the document, or to apply italics, underlining, color, line numbering, or other editing to specific parts of the document.

### SUMMARY

According to aspects of the embodiments, there is provided methods of controlling operation of a printer, and corresponding apparatus and computer-readable medium. The methods include receiving a print command from a user, in response to the received print command, displaying to the user a print user interface including selectable editing settings, the selectable editing settings including settings for varying attributes of a document to be printed, the editing settings for varying formatting of the document to enhance editing by hand of the printed document; receiving from a user a selection of the editing settings; and controlling printing of the document to print on the printer by varying formatting of the document using the selected editing settings.

### BRIEF DESCRIPTION OF THE DRAWINGS

FIG. 1 illustrates a block diagram of a system for controlling a printer;

FIG. 2 illustrates a block diagram of a system for controlling a printer;

FIG. 3 illustrates a diagram of a print user interface;

FIG. 4 illustrates a diagram of a print user interface;

FIG. 5 illustrates a diagram of a print user interface; and

FIG. 6 illustrates a flowchart of a method for controlling a printer.

### DETAILED DESCRIPTION

Aspects of the embodiments disclosed herein relate to methods for controlling operation of a printer, and corresponding apparatus and computer-readable medium. The disclosed embodiments allow a user to print documents using one or more editing settings.

The disclosed embodiments include methods of controlling operation of a printer. The methods include receiving a print command from a user, in response to receiving the print command, displaying to the user a print user interface including selectable editing settings, the selectable editing settings including settings for varying attributes of a document to be printed, the editing settings for varying formatting of the document to enhance editing by hand of the printed document, receiving from a user a selection of the editing settings, and controlling printing of the document to print on the printer by varying formatting of the document using the selected editing settings.

The disclosed embodiments further include an apparatus for controlling printing of a document on a printer. The apparatus includes a memory that stores print driver instructions; and a processor that executes the print driver instructions to cause printing of the document when receiving a print command for printing from a user by: in response to receiving a print command from a user, displaying to the user a print user interface including selectable editing settings, the selectable editing settings including settings for varying attributes of a document to be printed, the editing settings for varying formatting of the document to enhance editing by hand of the printed document; and controlling printing of a document to print on the printer using the selected editing settings.

The disclosed embodiments further include a computer-readable medium that includes a computer-usable data carrier storing instructions, the instructions when executed by a computer causing the computer to control printing by: in response to receiving a print command from a user, displaying to the user a print user interface including selectable editing settings, the selectable editing settings including settings for varying attributes of a document to be printed, the editing settings for varying formatting of the document to enhance editing by hand of the printed document, receiving from a user a selection of the editing settings; and controlling printing of the document to print on the printer by varying formatting of the document using the selected editing settings.

The term “application” in the disclosed embodiments refers to a program designed for end users of a computing device, such as a word processing program, a database program, a browser program, a spreadsheet program, a gaming program, and the like. An application is distinct from systems programs, which consist of low-level programs that interact with the computing device at a very basic level, such as an operating system program, a compiler program, a debugger program, programs for managing computer resources, and the like.

A printer “editing setting” in the disclosed embodiments refers to a setting of an attribute of a document to be printed that can be selected by a user and typically varies the attribute for printing from the attribute as saved in the document, that is used for printing of the document on a one time basis, where variation of the attribute will enhance hand editing of the printed document by varying the formatting of the document. The editing settings do not get saved in the application version of the document; for example if the document is saved as a Word document, the saved version of the Word document will not be modified to include the editing settings. Examples of printer editing settings are settings that vary the formatting to enhance editing of the document such as for line spacing, line numbering, page margins, and keyword editing applied to selected keywords or phrases, such as bolding, underline, italics, font, color, strikethrough, redact and color applied to a keyword or phrase selected by the user.

A “print user interface” as used herein is a user interface that may be displayed to a user upon receiving a print command from the user. The print user interface typically will include items allowing the user to select from among various formatting functionality that may be selected and applied in a printed document.

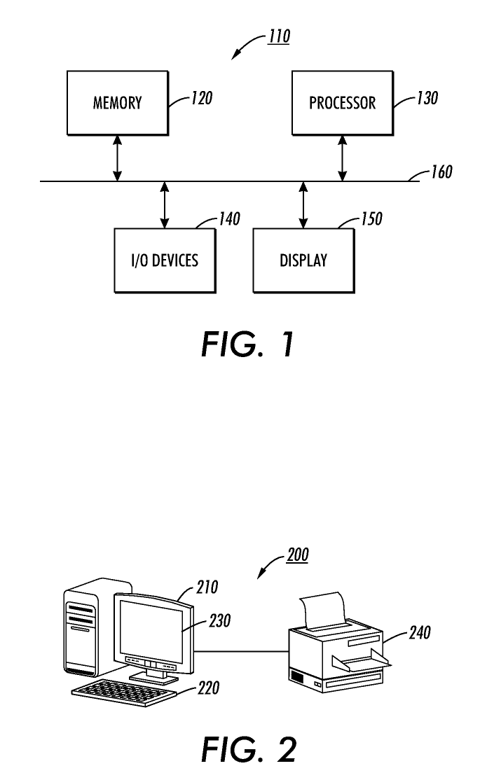

FIG. 1 illustrates a diagram of a system 110. The system 110 may be embodied within devices such as a desktop computer, a laptop computer, a handheld computer, a handheld communication device, another type of computing device, or the like. The system 110 may include a memory 120, a processor 130, input/output devices 140, a display 150 and a bus 160. The bus 160 may permit communication and transfer of signals among the components of the computing device 110.

Processor 130 may include at least one conventional processor or microprocessor that interprets and executes instructions. The processor 130 may be a general purpose processor or a special purpose integrated circuit, such as an ASIC, and may include more than one processor section. Additionally, the system 110 may include a plurality of processors 130.

Memory 120 may be a random access memory (RAM) or another type of dynamic storage device that stores information and instructions for execution by processor 130. Memory 120 may also include a read-only memory (ROM) which may include a conventional ROM device or another type of static storage device that stores static information and instructions for processor 130. The memory 120 may be any memory device that stores data for use by system 110.

Input/output devices 140 (I/O devices) may include one or more conventional input mechanisms that permit a user to input information to the system 110, such as a microphone, touchpad, keypad, keyboard, mouse, pen, stylus, voice recognition device, buttons, etc., and output mechanisms such as one or more conventional mechanisms that output information to the user, including a display, one or more speakers, a storage medium, such as a memory, magnetic or optical disk, disk drive, a printer device, etc., and/or interfaces for the above. The display 150 may typically be an LCD or CRT display as used on many conventional computing devices, or any other type of display device.

The system 110 may perform functions in response to processor 130 by executing sequences of instructions or instruction sets contained in a computer-readable medium, such as, for example, memory 120. Such instructions may be read into memory 120 from another computer-readable medium, such as a storage device, or from a separate device via a communication interface, or may be downloaded from an external source such as the Internet. The system 100 may be a stand-alone system, such as a personal computer, or may be connected to a network such as an intranet, the Internet, or the like.

The memory 120 may store instructions that may be executed by the processor to perform various functions. For example, the memory may store printer driver instructions to allow the system to perform various printing functions in association with a particular printer connected to the system. The printer driver instructions are typically unique to each specific type of printer, and the system 110 may store a plurality of print drivers each for a different printer.

FIG. 2 illustrates a system 200. The system 200 includes a computer 210, which includes the elements of system 110, including the memory 120, the processor 130, I/O devices 140 and a display 150. The computer 210 could be a standard personal computer, or could be another type of computing device such as a handheld computer, a phone, a laptop computer, or the like.

The system 200 may also include a keyboard 220 functioning as an input device. The keyboard may be replaced or supplemented by the input devices as described in relation to FIG. 1.

The system 200 may also include a display 230 functioning as an output device for displaying images generated or received by the computer 210, corresponding to display 150 shown in FIG. 1. The display 230 may display images to be viewed by a user, such as various application programs, a user interface (UI), text, photographic images, or the like. For example, the display may generate a user interface in response to a print driver stored in memory 120, such as a user interface for the print driver. The print driver could also be stored in a memory in a network that the computer 210 is connected to, such as in a network server.

The system 200 may have a printer 240 connected thereto for printing data such as images, text, or the like in response to a user directing the computer 210 to print, for example. In response to such a print command, the processor will typically cause the print driver to communicate with the printer to perform the needed printing.

The system 200 may be connected to a network, such as such as an intranet, the Internet, a wireless network, or the like. In addition, the system 200 may be connected to a plurality of printers such as printer 240. The plurality of printers may be of a same printer type or of varying printer types.

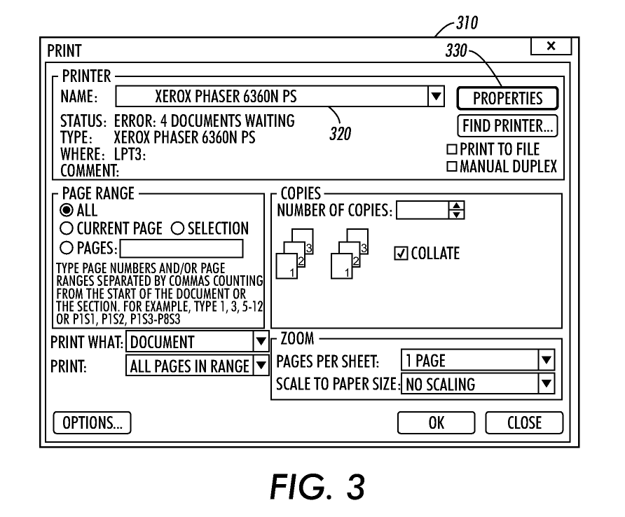

FIG. 3 illustrates a printer user interface 310 that may be displayed on a display of computer 210. The printer user interface 310 may be invoked and displayed when a user selects a print function or command on the computer 210, typically using an input device such as keyboard 220, for example. The user may typically select a printer in the printer selection area 320. The user will typically be able to select from all printers for which a print driver has been loaded into memory of the computer 210. In the case of the FIG. 3 example, the user can select from printers through the use of a drop-down menu, and printers other than the one shown may be selected. Upon selection of properties 330, a further printer user interface 410 may be displayed. Embodiments may also display the print user interface 410 directly upon receiving a print command from a user. The print user interfaces 310, 410 are example interfaces, and other print user interfaces may be used.

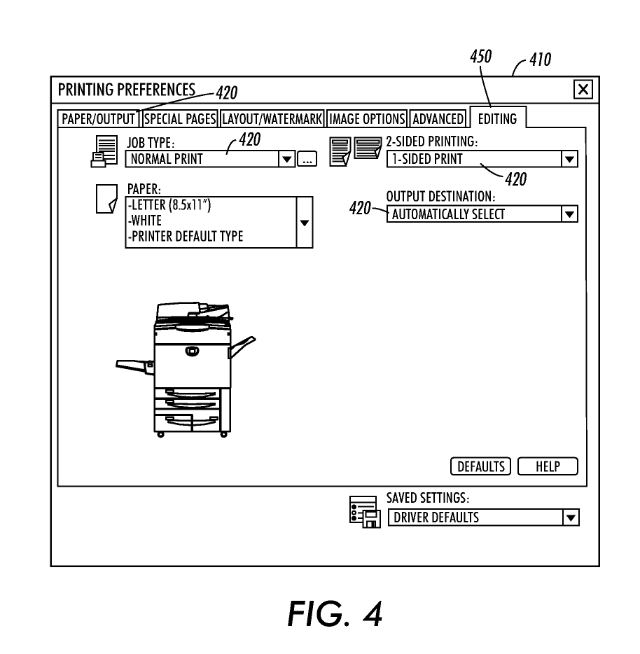

FIG. 4 illustrates an exemplary diagram of a further printer user interface 410 that may be displayed on a display of computer 210, for example. The printer user interface 410 includes one or more printer document settings 420 that may be selected and set by the user. The document settings 420 are settings of an attribute of a document to be printed. The user may select and save different printer document settings 420 prior to printing. For example, the printer document settings may include paper, output, special pages, layout, watermark, image options, advanced, editing, and so forth. The paper setting may allow selection of a paper size, a paper color, or other paper features. The output setting may include a selection of 1 or 2 sided printing, a print quality, a destination, or the like.

A layout setting may allow selection of page layout features such as portrait, landscape, number of sheets per page, or the like. A watermark setting may allow selection of watermark features such as draft, confidential, print in background, or the like. An image options setting may allow selection of features such as application reduce/enlarge, PostScript pass-through, mirrored output, or the like. An advanced setting may allow selection of features such as booklet layout, image color management, or the like.

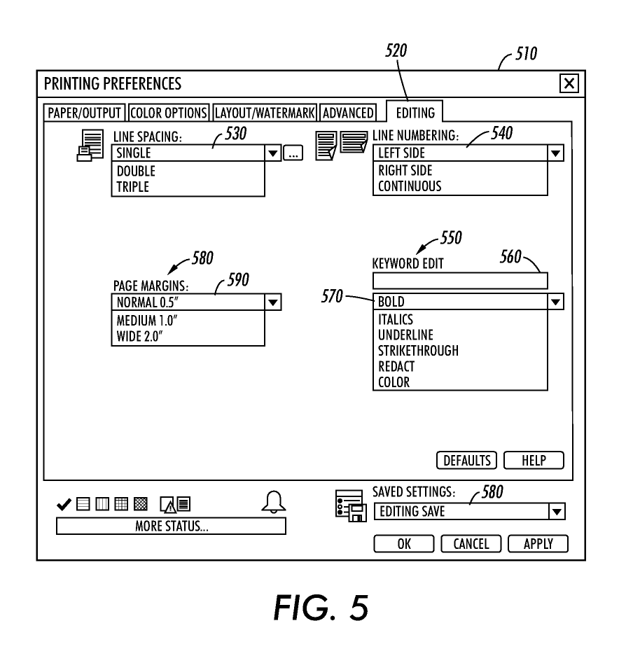

The printer user interface 410 also includes an editing setting 450 that may be in the form of a tab. The editing setting 450 may be useful for setting editing variations to the page to be printed, such as may be useful for annotation or other editing by a user, where the editing variations may be set and printed on a copy of the page used for such annotations, but not used on a copy used for final distribution. Selection of the editing setting 450 may open an additional printer user interface showing available editing selections, such as the printer user interface 510 as shown in FIG. 5.

The printer user interface 510 may include the editing tab 520 which has been selected from the printer user interface 410, for example. The printer user interface 510 includes various editing settings that may be selected by a user, including a line spacing setting 530, a line numbering setting 540, a keyword edit setting 550, and a page margin setting 580.

The line spacing setting 530 may be in the form of a drop down menu, allowing the user to select from various line spacing, such as single, double triple, and the like. Any variation of the line spacing could be used, and the use of a drop down menu is not required, but is instead an example embodiment.

The line numbering setting 540 may be in the form of a drop down menu, allowing the user to select from various line numbering to be added to the document. The user may select line numbering on the left side, on the right side and continuous. Any variation of line numbering features could be used, and the use of a drop down menu is not required, but is instead an example embodiment.

The keyword edit setting 550 allows the user to type in a keyword or phrase in the box 560, and then to select various editing to appear in the document applied to the keyword. For example, with the drop down menu 570, the user may select various editing such as bold, italics, underline, strikethrough, redact, color, and the like to be applied to the keyword.

The page margin editing setting 580 allows the user to select a page margin setting to be added to that as saved in the original document through the use of a drop down menu at 590. In the example shown in FIG. 5, the user may select between normal 0.5″, medium 1.0″ and wide 2.0″, which would be added to the margins of the page as saved in the original document. The added margins may be useful to allow additional room for hand annotations or the like. The added margins are used for a one time printing of the document, and are not saved as a part of the document in its application.

The page margin editing setting illustrated in FIG. 5 is only one example that could be used. The left right, top and bottom margins could be individually selectable and different from each other, and the printer user interface could allow the user to select any amount to be entered for any of the margins.

If the user selects one or more of the editing settings that varies the values from those saved in the document to be printed and then prints the document from the printer user interface, the document will be printed with the selected editing settings incorporated into the document. For example, from the printer user interface 510, the user may select the editing settings double line spacing, left side line numbering, and underline of the keyword “cash” using the line spacing setting 530, the line numbering setting 540, and the keyword edit setting 550. If the user then prints the document from the printer user interface 510, such as by selecting the OK button at the bottom of the printer user interface 510, the document will be printed with the selected editing settings. However, if the user were to close the printer user interface, later open the document in its application and print, the editing settings would not be included in the printed version of the document unless the user again selected them from the printer user interface, since the editing settings are not saved into the document.

The editing settings shown and described herein are only examples. Any editing settings may be used including those that are selectable by the user. The editing settings are generally intended to be useful to a user who wants to edit a document, such as by applying handwritten annotations to a printed out version of the document that may be a first or subsequent draft. Accordingly, the editing settings are not saved as part of the document, and will generally not appear as part of the printed document if the user later prints the document after closing the printer user interface, unless the user again sets the editing settings.

However, the printer user interface 510 includes the ability to save the editing settings that have been selected as an editing save 580. If the user saves the settings as an editing save 580, the user may simply select editing save 580 to apply all of the previously saved editing settings. The user may create one or more groups of editing settings, and save them separately, by giving each a different name.

A user may select to print a document by using what is known as a “quick print.” Such a quick print may occur when the user selects a print icon, where no print user interface is opened, but the document simply prints in response to selection of the print icon, for example. During such a quick print, if the user has previously saved editing settings, embodiments will not use the saved editing settings.

When editing settings are selected by a user and printing then occurs from the print user interface, embodiments may apply the settings by modifying a page description language version of the document to be printed, such as a PostScript language version of the document, or any other page description language version, such as Printer Command Language (PCL), and the like. Such page description language versions of a document are created and sent to a printer for printing, and embodiments as described herein apply the editing settings by modifying the page description language file. Thus, the version of the document as saved in an application (e.g., Word) is not modified in preferred embodiments. As an alternative embodiment, the version of the document in its application could be modified for printing.

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

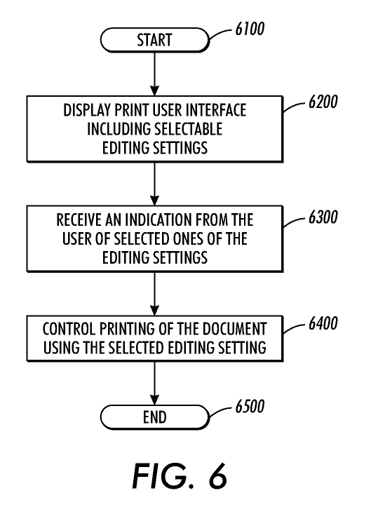

FIG. 6 illustrates a flowchart of a method of controlling a printer, as was further described herein. The method starts at 6100. At 6200, in response to receiving a print command from a user, a print user interface is displayed. The print user interface includes the selectable editing settings, the selectable editing settings including settings for varying attributes of a document to be printed, the editing settings for varying formatting of the document to enhance editing by hand of the printed document.

At 6300, an indication is received from a user of selected ones of the editing settings. At 6400, printing of the document is controlled using the editing setting. At 6500, the method ends.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of controlling a printing operation to a printer, comprising:
receiving a print command from a user;
in response to the received print command, displaying to the user a print user interface including selectable editing settings, the selectable editing settings including settings for varying attributes of a document to be printed, the editing settings for varying formatting of the document to enhance editing by hand of the printed document;
receiving from a user a selection of the editing settings; and
controlling printing of the document to print on the printer by varying formatting of the document using the selected editing settings.

2. The method of claim 1, wherein the editing selections include at least one of line spacing settings, line numbering settings or page margin settings.

3. The method of claim 1, wherein the editing settings include a keyword setting allowing the user to enter a keyword or phrase, and apply one of a plurality of formatting variations to all instances of the keyword or phrase in the document.

4. The method of claim 4, wherein the formatting variations to the selected keyword or phrase include at least one of bold, italics, underline, strikethrough, redact and color.

5. The method of claim 5, further comprising:
receiving an indication from the user of a selection of the keyword or phrase and a selected one of the formatting variations; and
controlling printing of the document to apply the selected one of the formatting variations to the selected keyword or phrase.

6. The method of claim 1, wherein the formatting variations include at least one of varying line spacing, varying line numbering, varying page margins, and varying formatting applied to selected keywords or phrases.

7. The method of claim 1, wherein the editing selections include line spacing settings, line numbering settings, page margin settings and a keyword setting allowing the user to enter a keyword or phrase and to select one of a plurality of formatting variations to be applied to all instances of the keyword or phrase in the document, further comprising:
receiving an indication from the user of at least one of: 1) the line spacing settings; 2) the line numbering settings; and 3) the a selection of the keyword or phrase and a selected one of the formatting variations; and
controlling printing of the document based on the received indications.

8. The method of claim 1, wherein controlling printing of the document to print on the printer by varying formatting of the document using the selected editing settings comprises creating a page description language file corresponding to the document, and applying the selected editing settings to the page description language file.

9. An apparatus for controlling printing of a document on a printer, comprising:
a memory that stores print driver instructions; and
a processor that executes the print driver instructions to cause printing of the document when receiving a print command for printing from a user by:
in response to receiving a print command from a user, displaying to the user a print user interface including selectable editing settings, the selectable editing settings including settings for varying attributes of a document to be printed, the editing settings for varying formatting of the document to enhance editing by hand of the printed document; and
controlling printing of a document to print on the printer using the selected editing settings.

10. The apparatus of claim 9, wherein the editing selections include at least one of line spacing settings, line numbering settings or page margin settings.

11. The apparatus of claim 9, wherein the editing settings include a keyword setting allowing the user to enter a keyword or phrase, and apply one of a plurality of formatting variations to all instances of the keyword or phrase in the document.

12. The apparatus of claim 11, wherein the formatting variations applied to the keyword or phrase include bold, italics, underline, strikethrough, redact and color.

13. The apparatus of claim 12, wherein the processor further controls printing by:
receiving an indication from the user of a selection of the keyword or phrase and a selected one of the formatting variations applied to the keyword or phrase; and
controlling printing of the document to apply the selected one of the formatting variations to the selected keyword or phrase.

14. The apparatus of claim 9, wherein the formatting variations include at least one of varying line spacing, varying line numbering, varying page margins, and varying formatting applied to selected keywords or phrases.

15. The apparatus of claim 9, wherein the editing selections include line spacing settings, line numbering settings, page margin settings and a keyword setting allowing the user to enter a keyword or phrase and to select one of a plurality of formatting variations to be applied to all instances of the keyword or phrase in the document, wherein the processor further controls printing by:
receiving an indication from the user of at least one of: 1) the line spacing settings; 2) the line numbering settings; and 3) the a selection of the keyword or phrase and a selected one of the formatting variations; and
controlling printing of the document based on the received indications.

16. The apparatus of claim 9, wherein the processor controls printing of a document to print on the printer using the selected editing settings by creating a page description language file corresponding to the document, and applying the selected editing settings to the page description language file.

17. A computer-readable medium, comprising:
a computer-usable data carrier storing instructions, the instructions when executed by a computer causing the computer to control printing by:
in response to receiving a print command from a user, displaying to the user a print user interface including selectable editing settings, the selectable editing settings including settings for varying attributes of a document to be printed, the editing settings for varying formatting of the document to enhance editing by hand of the printed document;
receiving from a user a selection of the editing settings; and
controlling printing of the document to print on the printer by varying formatting of the document using the selected editing settings.

18. The computer-readable medium of claim 17, wherein the editing selections include line spacing settings, line numbering settings or page margin settings.

19. The computer-readable medium of claim 17, wherein the editing settings include a keyword setting allowing the user to enter a keyword or phrase, and apply one of a plurality of formatting variations to all instances of the keyword or phrase in the document.

20. The computer-readable medium of claim 17, wherein the formatting variations applied to the keyword or phrase include bold, italics, underline, strikethrough, redact and color, and the instructions further control printing by:
receiving an indication from the user of a selection of the keyword or phrase and a selected one of the formatting variations to apply to the selected keyword or phrase; and
controlling printing of the document to apply the selected one of the formatting variations to the selected keyword or phrase.

21. The computer-readable medium of claim 17, wherein the formatting variations include at least one of varying line spacing, varying line numbering, varying page margins, and varying formatting applied to selected keywords or phrases.

22. The computer-readable medium of claim 20, wherein the editing selections include line spacing settings, line numbering settings, and a keyword setting allowing the user to enter a keyword or phrase and to select one of a plurality of formatting variations to be applied to all instances of the keyword or phrase in the document, and the instructions further comprise instructions causing the computer to control printing by:
receiving an indication from the user of at least one of: 1) the line spacing settings; 2) the line numbering settings; and 3) the a selection of the keyword or phrase and a selected one of the formatting variations; and
controlling printing of the document based on the received indications.

23. The computer-readable medium of claim 17, wherein the computer controls printing of a document to print on the printer using the selected editing setting by creating a page description language file corresponding to the document, and applying the selected editing settings to the page description language file
